(19) United States
(12) Patent Application Publication
(10) Pub. No.: US 2014/0257853 A1
(43) Pub. Date: Sep. 11, 2014

(54) Health Data Collection and Analysis Device and System

(71) Applicant: Yen-Ju Huang, Taipei (TW)

(72) Inventor: Yen-Ju Huang, Taipei (TW)

(21) Appl. No.: 14/201,297

(22) Filed: Mar. 7, 2014

Related U.S. Application Data
(60) Provisional application No. 61/773,935, filed on Mar. 7, 2013.

(51) Int. Cl. G06F 19/00

(52) U.S. Cl. CPC G06F 19/3456; G06F 19/322
USPC 705/3

(57) ABSTRACT

A health data collection and analysis device comprises at least one processor, at least one input unit, at least one examination unit, and at least one storage unit. The input unit is a means for a health care profession or patient updating a medication record or medical record. The examination unit is connected with the processor. The examination unit is a means for examining the user and obtaining at least one examination record. The storage unit is a means for saving the medication record or medical record and the examination record. The processing unit integrates the medication record or medical record and the examination record and the result will help the health care profession to evaluate the health state of the user. The better advice will be provided by the health care profession.

### CROSS-REFERENCE TO RELATED APPLICATION

This application claims the benefit of U.S. Provisional Application No. 61/773,935 filed on Mar. 7, 2013 in the United State Patent and Trademark Office, the disclosure of which is incorporated herein by reference.

### BACKGROUND OF THE INVENTION

1. Field of the Invention

The present invention generally relates to a device assisting pharmacists, doctors, or other health specialists, regular user, and patients for collect and analyze the health data.

2. Description of the Related Art

Medicine record is more and more important now due to the development of a country. Keeping such record, a doctor in a hospital or a pharmacist in a pharmacy will know what and how the medicine/drug had been taken by the patient. The doctor can prescribe medicine relying on the previous medicine record; the pharmacist can advise health product or Over-The-Counter drug (OTC drug). Especially when the pharmacy has multiple branches, sharing the medicine among branches will keep the medicine record more complete.

Taiwan Utility Patent No. M445736 discloses a medicine record management system which helps a patient to get his medicine from different pharmacy branches. The system will need carrier, handling pharmacy and final pharmacy. The system includes handling reader, handling terminal, server, and final terminal. The handling reader is arranged in the handling pharmacy and reading the original digital prescription from the carrier. The handling terminal is arranged in the handling pharmacy and electrically connected to the handling reader. The handling terminal include encryption unit and handling transmitting unit. The encryption unit utilizes the code of the handling terminal to create a key to encrypt the original digital prescription and then further creates an encrypted digital prescription. The handling transmitting unit transmit the encrypted digital prescription. The server include a database receiving unit, medicine record database and a database transmitting unit. The database receiving unit receives the encrypted digital prescription from the handling terminal. The medical record database stores that encrypted digital prescription. The database transmitting unit transmits the encrypted digital prescription. The final terminal has a final receiving unit and a decryption unit. The final receiving unit receives the encrypted digital prescription from the database transmitting unit. The decryption unit utilize the key to decrypt the encrypted digital prescription to get the original digital prescription.

The digital prescription mentioned above is able to transmit from one pharmacy to another. Therefore the patent can get his medicine from different pharmacy. However the interaction between a patient and a pharmacist is still limited. For example, when the patent takes the carrier or prescription to the pharmacy and the pharmacist collect the medicine based on the prescription, the patient needs to do and has to do is waiting. After the patient gets his medicine and hear some explanation from the pharmacist, he may leave soon. The advice the pharmacist can give to the patient is quite limited because the reference data of the patients limited. In addition, for OTC drug and other health promoting product, such system cannot provide pharmacist or other health specialists with solid basis material for reference.

The above information disclosed in this Background section is only for enhancement of understanding of the background of the described technology and therefore it may contain information that does not form the prior art that is already known to a person of ordinary skill in the art.

### SUMMARY OF THE INVENTION

The primary objective of the present invention is to provide a device for a user to record medication record, examination record, activity records, etc., and such records would be integrated by the present invention. In health related institution such as the pharmacy, when the pharmacist preparing the medicine or other health product for a client, the client can also utilize his or her time by using the present invention, building a series of health record. The present invention can further help pharmacist or other specialist to notice the correlation of the medicine/OTC drug/health product/activities and symptom. After figuring out the correlation the correlation, the pharmacist or specialist can advise in a better way or refer the client to a right direction.

The present invention, health data collection and analysis device, comprises at least one processor, input unit, examination unit, and storage unit. The input unit is a means for updating a medicine record; the examination unit connects with the processor and examines a user to obtain at least one examination record; the storage unit for storing the medicine record and the at least one examination record. The processor integrates the medicine record and the examination record stored in the at least one storage unit.

The present invention, health data collection and analysis device, comprises at least one processor, input unit, and storage unit. The input unit is a means for updating a medicine record which includes records of medicine had been taken and records of subjective symptoms; the storage unit is a means for storing the records of medicine had been taken and the records of subjective symptoms. The processor integrates the records of medicine had been taken and the records of subjective symptoms.

The present invention, health data collection and analysis system, comprises at least one terminal, and server. The terminal has at least one input unit for updating a user's medicine record, at least one examination unit for obtaining at least one examination record, and at least one output unit. The server connecting with the terminal and including at least one storage unit for storing the medicine record and examination record collected by the terminal.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 illustrates the first embodiment of the present invention in a pharmacy;

FIG. 2 is a structure diagram of the first embodiment of the present invention;

FIG. 3 illustrates the input unit in the first embodiment;

FIG. 4 illustrates the output unit in the first embodiment;

FIG. 5 illustrates the communication between the present invention and the external device in the first embodiment;

FIG. 6 illustrates the category of the storage unit in the first embodiment.

FIG. 7 is an analysis diagram of the first sub-embodiment;

FIG. 8 is an analysis diagram of the second sub-embodiment;

FIG. 9 is an analysis diagram of the third sub-embodiment;

FIG. 10 is an interaction flow chart for Lumbodynia; and

FIG. 11 is a structure diagram of the second embodiment of the present invention.

### DETAILED DESCRIPTION OF THE PREFERRED EMBODIMENTS

Details of the objects, technical configuration, and effects of the present invention will be described more fully hereinafter with reference to the accompanying drawings, in which exemplary embodiments of the invention are shown. The like reference numerals indicate the like configuration throughout the specification, and in the drawings, the length and thickness of layers and regions may be exaggerated for clarity. The technical content of the present invention will become apparent by the detailed description of the following embodiments and the illustration of related drawings as follows. As used herein, the term “and/or” includes any and all combinations of one or more of the associated listed items.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The health institution mentioned in the following description includes but not limits hospitals, clinics, pharmacies, and medical instrument stores. The health specialists mentioned in the following description includes but not limits medical doctors, pharmacists, nutritionist registered nurse and licensed practical nurse, and any other person providing health related service.

The present invention can be arranged in pharmacies, hospitals, or other health institution. Besides, multiple present inventions can be arranged in different locations, sharing the same database to broadly record the users'health information/data.

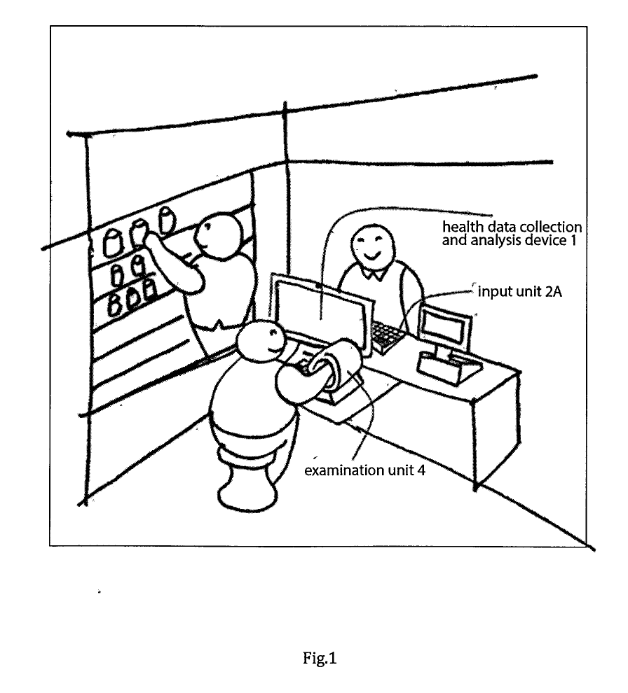

Please refer to FIG. 1. FIG. 1 is illustrated the first embodiment of the present invention in a pharmacy. The user, waiting the pharmacist who is inputting the prescriptions to the medication record and preparing the medicine based on that prescriptions, utilizes the present invention health data collection and analysis device 1 to collect and analyze the data. The present invention can also be operated in a hospital. When a doctor review the medical record or inputting the examination results or prescribing, the doctor can utilize the present invention to retrieve the patient's health information/data. In that circumstance, the doctor and patient can use their time efficiently.

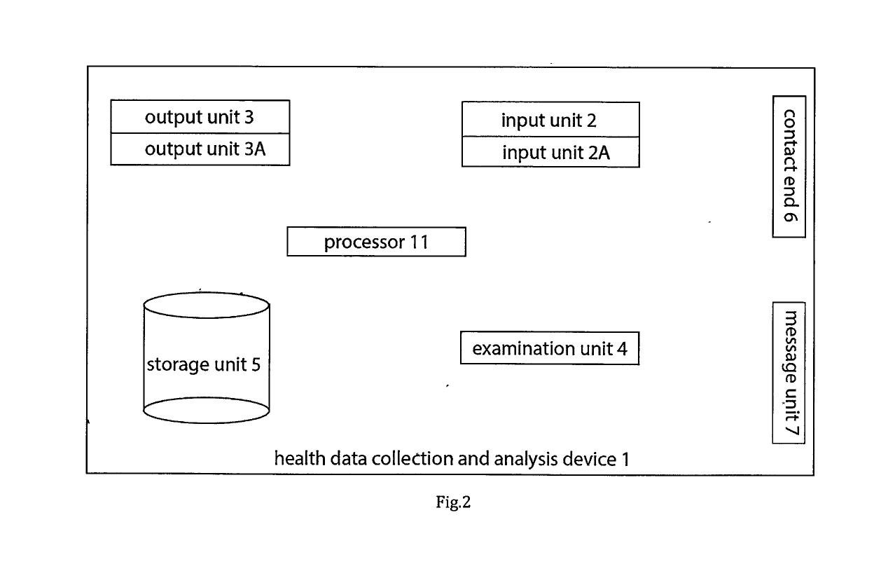

FIG. 2 is structure diagram of the first embodiment of the present invention. The present invention health data collection and analysis device 1 comprises at least one input unit 2, output unit 3, examination unit 4, storage unit 5, connect end 6, and message unit 7. The input unit 2, output unit 3, examination unit 4 and storage unit 5 can be controlled by the processor 11 of the health data collection and analysis device 1. The use can input the data via input unit 2 to confirm his/her identity. The output unit 3 is used for showing the information/data inputted by the user, information of the user stored in the storage unit 5, or the related information after the processor processed to the user via printing or displaying on the screen. The storage unit 5 saves personal information and that information is separated corresponding to each user/individual's account. In the first embodiment, the present invention health data collection and analysis device can further comprise an input unit 2A and an output unit 3A. The input unit 2A and output unit 3A could be utilized by doctor to input data to the medical record or by the pharmacist to input data to medication record. The first embodiment only shows the interaction between the patient and the pharmacist, but in fact, the health care member is not limited to pharmacist.

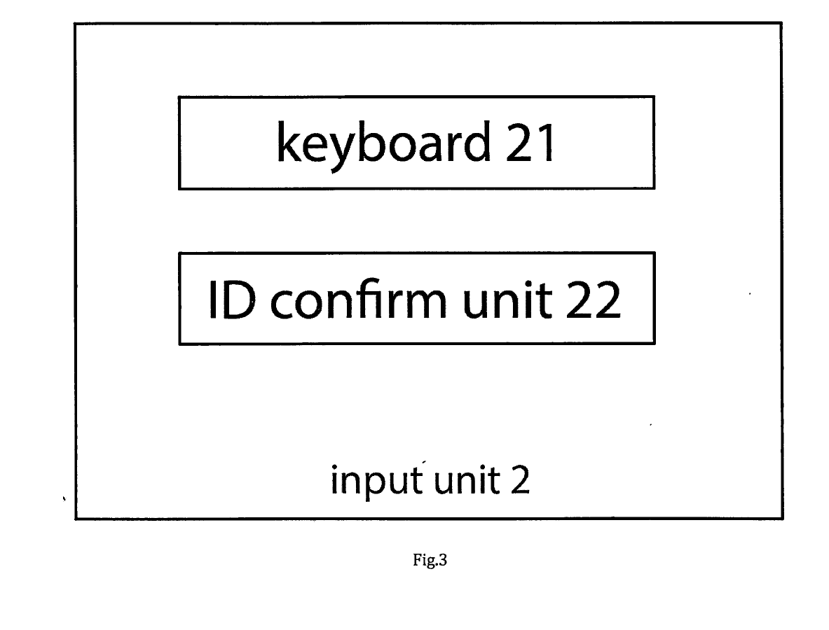

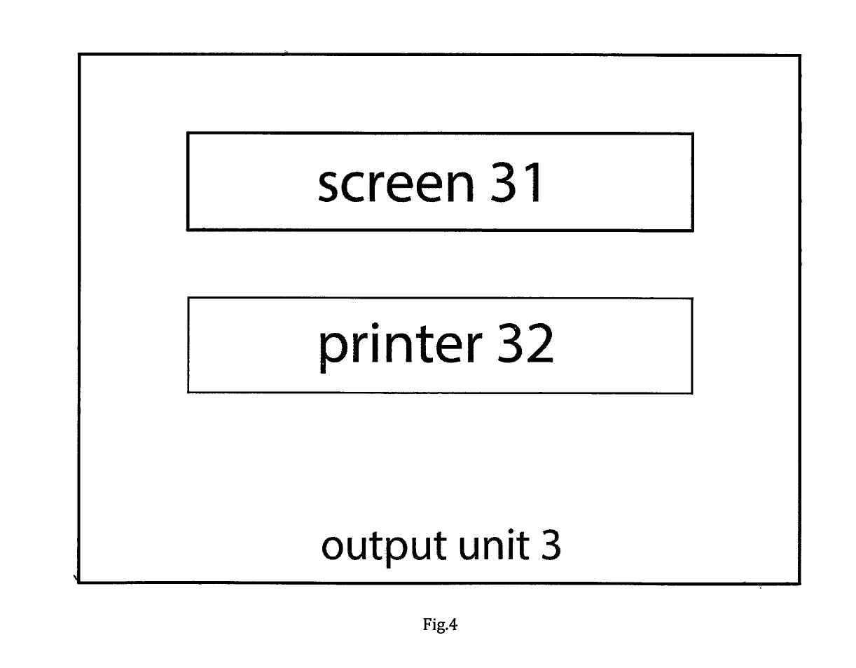

Please refer to FIG. 3. In the first embodiment, the input unit 2 further comprise a keyboard 21 and an ID confirm unit 22. The keyboard 21 can be wire or wireless apparatus, or even virtual keyboard shown on the screen. By pressing the physical keyboard or touching the icon of the virtual keyboard to input the data, it is available for the present invention to confirm the identification. The keyboard 21 in this embodiment is only for demonstrating purpose; the input unit 2 can also be other apparatus for inputting, such as mouse, remote controller, or even a hand-held device (e.g. smartphone or tablet) can be an input unit 2 or part of input unit 2. The input unit can also be a scanner (figure not shown). The scanner scan the document and save a copy into the storage unit 5. Please refer to the FIG. 4 which shown the output unit 3 includes a screen 31 and a printer 32. The screen 31 can be a screen or touch screen/panel (comprise input and output function). When a user input the data, the screen 31 is able to display the data simultaneously.

It is essential to confirm the identification when someone tries to take medicine from pharmacy. Please refer to FIG. 2 and FIG. 3, the ID confirm unit 22 of input unit 2 further confirm the whether a person is the exact person who supposed to get the prescription. The ID confirm unit 22 can be a card reader, fingerprint machine, facial scanner, sensor, or the combination thereof. The ID confirm unit 22 can further combine with the account-password system to further secure identity theft or misuse. In this embodiment, the ID confirm unit is card reader which has at least one slot to be inserted by ID confirmation card, such as insurance card, identification card, or the membership card designed for the present invention. The card reader reads the identification code in the card, temperately stores the code in to the RAM, and the processor 11 compares a code pre-stored in the storage unit 5. If these two codes match, the built-in program in the present invention will continue the following process; if these two codes do not match, the present invention will notify the health care person and warning those persons to notice whether the user/medicine taker is the exact patient. Card reader combined with account login system can avoid the possibility of fraud. Also, it is eligible that user first inserts the card into the card reader, and then the directly input the password without inputting the account name. The card reader described in this embodiment is only for demonstration; it is eligible to user sensor attain equivalent function. The sensor can sense the carrier which designed to interact with the sensor. Similarly, if the ID confirm unit 22 is fingerprint machine or facial scanner or other apparatus using the feature of the body to confirm the identity, the present invention is able to use features' data/information stored in the storage unit 5. If these two feature match, the built-in program in the present invention will continue the following process; if these two features do not match, the present invention will notify the health care person and warning those persons to notice whether the user/medicine taker is the exact patient. If the user and the patient is the same person and it is the first time to use the present invention, on the agreement of the user, a new code, fingerprint, appearance or other feature will stored in the storage unit 5 for the ID confirmation next time. Especially when a user using the facial scanner first time, the present invention will take the picture of the user for storage. Heath care member, such as pharmacist, can use the picture stored in the storage unit 5 and shown on the screen 3A to compare the medicine taker.

In the present invention the examination unit 4 is used for examining the user's body condition. The examination unit includes but not limits blood pressure monitor, vascular elasticity monitor, pulse oximeter, body fat monitor scale, blood glucose meter, etc. to examine blood pressure, heart rate, body age, Arterial Stiffness Index (ASI), Ankle-brachial Index (ABI), Oxyhemoglobin saturation by pulse oximetry (SpO2) and body mass index (BMI), etc. The examination data will be saved in the storage unit 5. By the ID confirm process operated by the input unit 2 to exclude the situation which the medicine taker is not the patient per se, the examination data will not erroneously saved into the patient's account. Therefor the data is reliable.

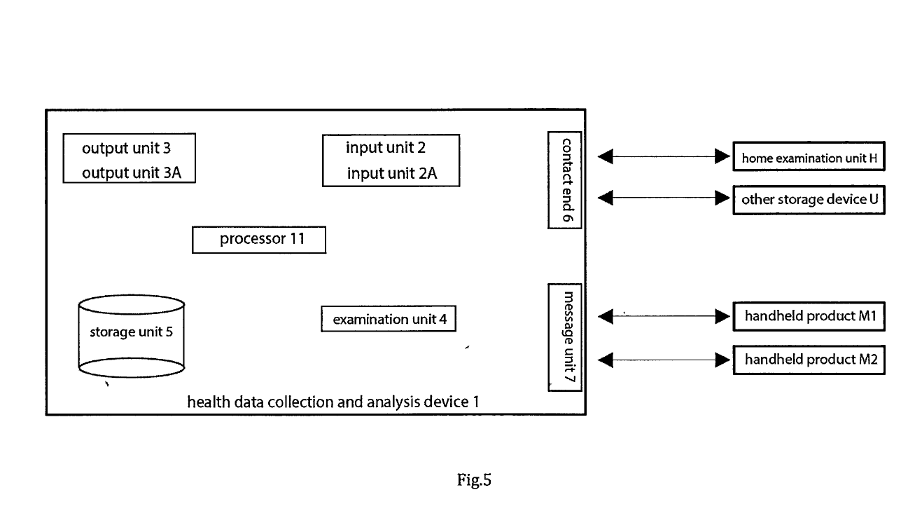

Please refer to FIG. 5. The present invention further comprises at least one contact end 6 and a message unit 7 used for supplement the health data. The contact end 6 can be USB port, 1394 port or SD slot, etc. which communication other examination unit which could be external. Via the contact end 6 communicating with the user's home examination unit H (such as blood glucose meter), a blood glucose data saving in the blood glucose meter will further be transmitted and saved into the storage unit 5. The contact end 6 is able to contact with other storage unit U (such as USB flash drive). The data in the storage unit U will further be transmitted and saved into the storage unit without taking heavy and expansive apparatus. For example, the data could be bone mass density or lutein level in the eye which examined in the hospitals, clinics, or pharmacies. The message unit 7 can be used to transmit or receive wireless signals by means of Bluetooth, infrared transmission, or other method to a handheld product M. The user can use the handheld product M (when multiple users use their handheld product M1, M2 . . . the message unit 7 can transmit/receive data with them) to input the account and password and upload health data/information into the present invention. Therefore, in this embodiment, when the pharmacist preparing the medicine, the user takes health examination to get more health information and save that into the personal account in the storage unit 5. Therefore the user/patient and the pharmacist both efficiently utilize their time. If the present invent is used in the hospital or clinics, the information can directly be recorded.

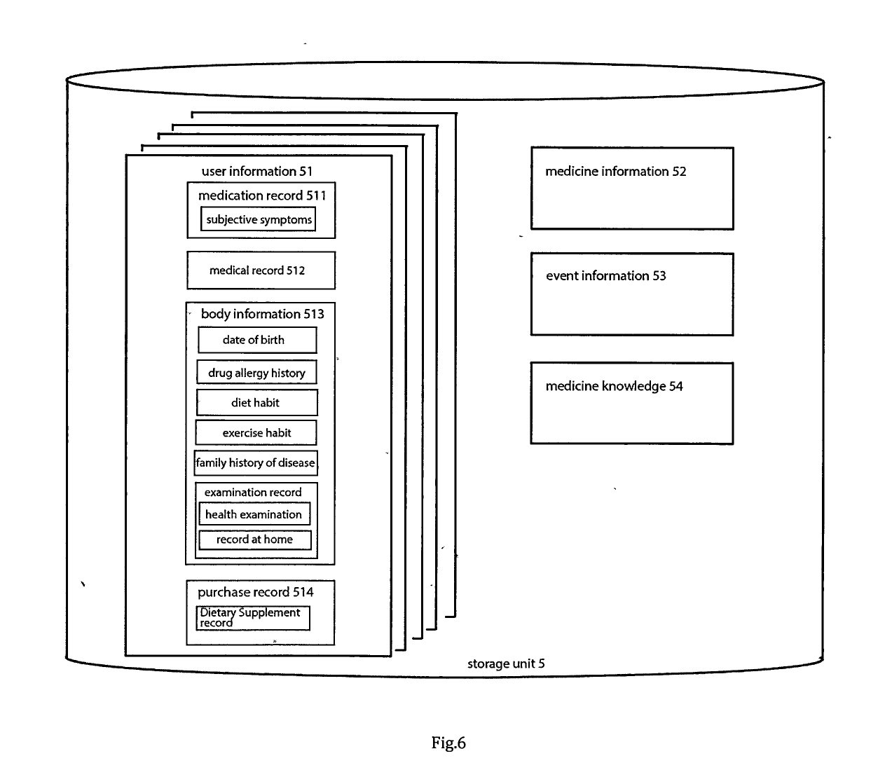

The storage unit 5 is used for saving huge amount of information, including personal information and the specific categories of information which a pharmacy or other health related institution prepared for the end-user. In such manner, the processor 11 processes and compares the data, assisting pharmacist and doctor to retrieve more detail reference. Please refer to FIG. 1 and FIG. 6, in the present invention, the content saved in the storage unit 5 includes user information 51, medicine information 52, event information 53, and medicine knowledge 54. The operation method for saving has been mentioned above. The user and pharmacist/doctor input data via input unit 2 and input unit 2A; the examination unit 4 upload the examination data/result into the storage unit 5 or the contact end 6 and message unit 7 upload the examination data/result, health information into the storage unit 5.

The user information 51 includes medication record 511, medical record 512, body information 513, and purchase record 514. Details are as follows.

A. medication record 511: it record prescription drugs and over-the-counter (OTC) drugs. When a pharmacist or other health care specialist communicates with the patient, they can further the input the data via input unit 2A to record the users' subjective symptoms (allergy and dizziness, etc.) after taking the medicine. The patient can also record be himself for pharmacist or other health specialists to consider the drug safety.

B. medical record 512: record the patient's appointed time, appointed department, and diagnosis. Using the appointed times as a baseline and comparing different appointed departments the user went to, the user/doctor, or pharmacist are able to review and understand the patient's history of appointed departments and diagnosis.

C. body information 513: it includes date of birth, drug allergy history, diet habit, exercise habit, family history of disease, examination record/result, etc. The examination record includes include height, weight, blood pressure, blood lipid, blood glucose, heart rate, body age, Arterial Stiffness Index (ASI), Ankle-brachial Index (ABI), Oxyhemoglobin saturation by pulse oximetry (SpO2) and body mass index (BMI), etc. These data/information may derived from the examination of the present invention, other medical institutes, or the patent's self examination at home. Each examination result will be appended with time information, such that the results are easy to be analyzed with other results.

D. purchase record 514: for pharmacies, except the prescription drug or OTC drug, they also sell many health product (dietary supplement) and medical equipment, such as probiotics or rehabilitation device. Such record is good for the health care member to realize the patients' health product consumption behavior.

The present invention utilizes the different data/information saved in the storage unit to process cross analysis based on the timeline, and assists doctors, pharmacists, health care member to evaluate the safety of the medicine or schedule the diet and exercise plan. For example, analyze the medicine record and examination results may help the doctor/pharmacist to understand medicine/drug's summary effect to the body, especially when taking various kinds of medicines at the same time which may lead to interaction. The medicine record may also include records of medicine had been taken and records of subjective symptoms. By the various records of the examination results and description of user's subjective symptoms, the doctor/pharmacist are able to have a detail information to evaluation toward the drug. Another example is that the present invention can save the user's particular disease in the storage unit. The doctor/pharmacist using the present invention to evaluate the drugs or provide diet and excise advice.

The following shows three sub-embodiments of the first embodiment. In the sub-embodiments, the storage unit 5 save the medicine record, particular disease record, diet habit, exercise habit, examination record/results. The processor 11, based on the time, compares values of the records and makes the analyzing diagrams, assisting pharmacist to provide appropriate advice to the patient. The prescribed medicine, OTC drug, health product, drug name, instruction, and dosage are only for demonstration purpose and it does not limit the scope of the present invention.

### First Sub-Embodiment of the First Embodiment

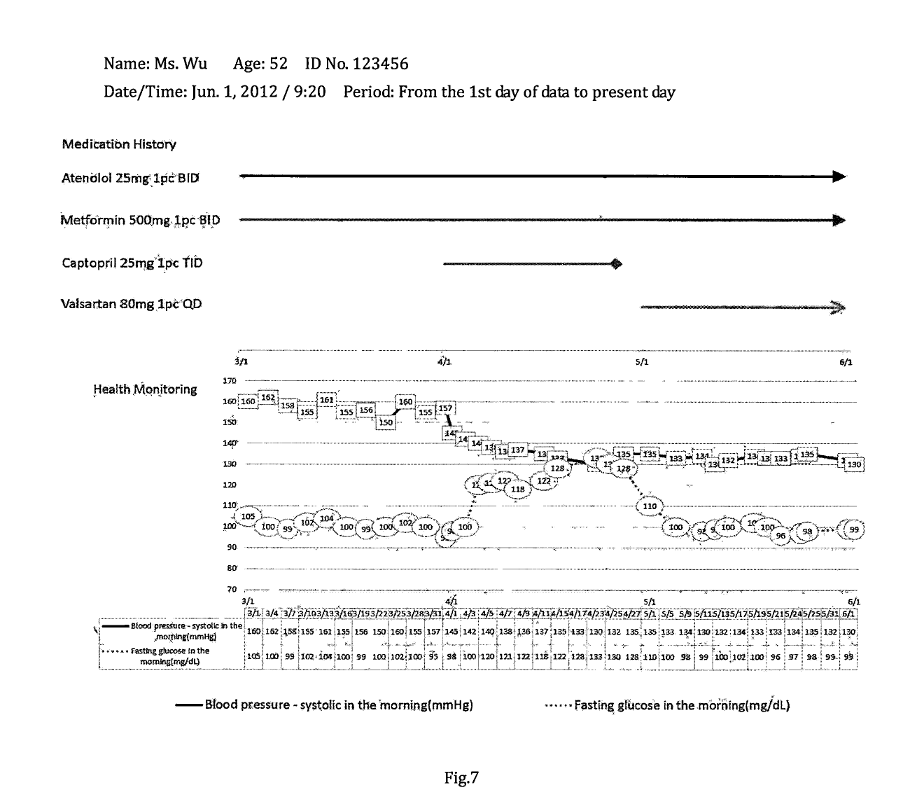

Please refer to FIG. 7, the analysis diagram of the first sub-embodiment. The upper part of FIG. 7 shows the user basic information, such name, age, reference number, etc. The middle part of FIG. 7 shows the diagram of the medicine record. In the first sub-embodiment, the horizontal axis represents the name of drugs, dosage, and instruction; the vertical axis represent the time, corresponding to the chart located the lower part of FIG. 7. Therefore in the upper part of the FIG. 7, the arrow tail means the beginning of a specific period of medicine record; the triangle arrow head means even though at the end of the specific period of medicine, the patient still takes medicine; the rhombus arrow head means the patient stop taking the medicine. The middle part of FIG. 7 illustration a diagram based on the examination data/information or the uploaded heath examination record. The solid line is systolic blood pressure in the morning (mmHg). The dotted line is fasting glucose in the morning (mg/dL). The vertical axis shows the values of blood glucose and blood pressure; the horizontal axis shows time.

In the first sub-embodiment, Ms. Wu (user/patient) used two drugs (Atenolol 25 mg 1PC BID and Metformin 500 mg 1PC BID) to control Diabetes and Hypertension. The value of blood glucose had been controlled well but the value of blood pressure is unstable even after taking the medicine. On March 1st, Ms. Wu got the chronic prescription medicine in a pharmacy having the present and began to use for a while. Observing the diagram illustrated by the present invention, Ms. Wu and pharmacist found that fasting glucose in the morning in the morning was under control but systolic blood pressure still remain in high level even by diet. Therefore on April 1st she went to see doctor again, and the doctor add a blood pressure drug (Captopril 25 mg 1PC TID) to control. By means of the third drug, Ms. Wu's blood pressure was under control. However, it is unexpected that blood glucose was higher than normal condition. Ms. Wu consulted the doctor again, mentioned that the diet was as usual and the blood glucose should not abnormal; this symptom may results from her flu. Because it was a first time for the doctor finding that Ms. Wu's blood glucose was abnormal, the doctor did not adjust the medicine. Instead, he told Ms. Wu's to monitor her blood glucose. If she recovered from the illness and she still had abnormal blood glucose, she should go to see a doctor as soon as possible. By continuing using the present invention, efficiently recording the examination record, comparing the medicine record, Ms. Wu helped the pharmacist notice that the period of rising blood glucose was correlated to the third prescription medicine (Captopril 25 mg 1PC TID), which both started from the beginning of April. The pharmacist could further ask whether Ms. Wu had continuous dry cough recently, which caused sleepless in the midnight and that insufficient sleep made the blood glucose unstable. This symptom might result from the side effect of Captopril rather than illness. The pharmacist print FIG. 7 and gave Ms. Wu. She took the diagram to when she went to see the doctor. The information helped doctor for evaluation. The doctor could change another medicine for Hypertension without coughing as side effect, such as Valsartan 80 mg 1 PC QD. After the replacement, no cough and Ms. Wu's blood pressure and blood glucose were under control. Based on Ms. Wu's age, history of disease, body condition, the doctor recommend Ms. Wu's control systolic blood pressure within 140 mmHg, fasting glucose in the morning control within 110 mg/dL. By the various record of the presentation, combined with the medicine record to create analysis diagrams, the present invention assisted the pharmacist to provide more accurate recommendation and the doctor to decide the prescription medicine.

### Second Sub-Embodiment of the First Embodiment

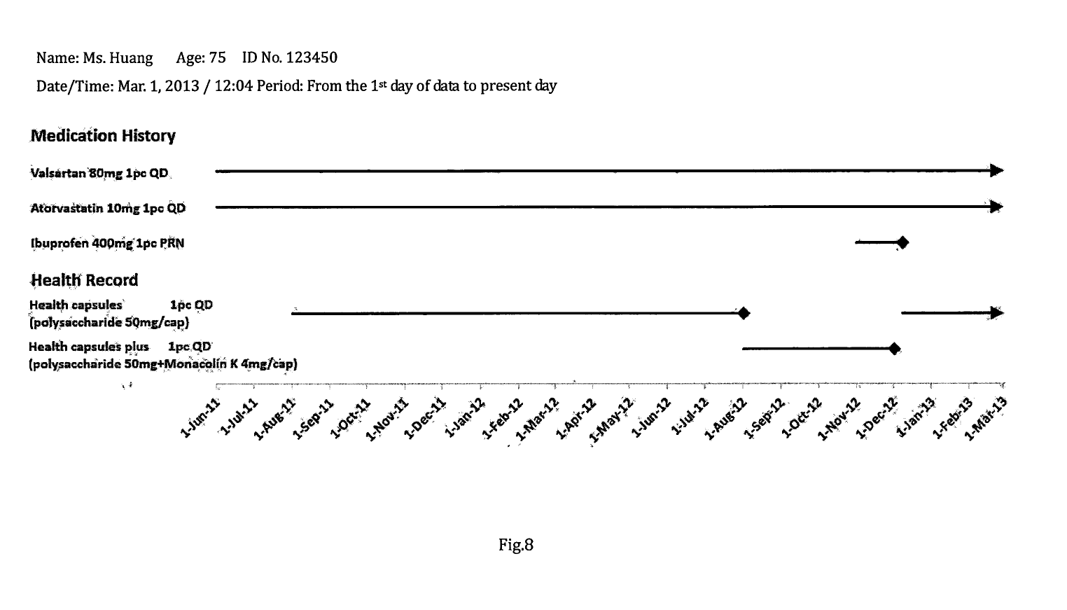

Please refer to FIG. 8, which illustrates the analysis diagram of the second sub-embodiment. The vertical axis shows the name of the drug, the health product's name, dosage and instruction; the horizontal axis shows the time.

FIG. 8 shows Ms. Huang's data. She suffered from slight Hypertension and high blood lipid. She had took two medicines (Valsartan 80 mg 1PC QD and Atorvastatin 10 mg 1PC QD) to control. In the August 2011, Ms. Huang further take a first generation health product capsule. Since Ms. Huang felt better condition, she kept taking these two medicines and one health product. One year later, in August 2012, the first generation health product producer started to market the second generation health product capsule. Ms. Huang chose the second generation health product capsule. However, three months later, in November 2012, she found she could not lift her arms over her head and she felt slight pain on her arms. She went to hospital for health examination but a doctor cannot found possible cause. Therefore consider Ms. Huang's age the doctor only add additional analgesics (Ibuprofen 400 mg 1PC PRN) to Ms. Huang. When Ms. Huang went to the pharmacy again to get the medicine, it is easy for the pharmacist to review Ms. Huang's medicine record via the present invention and found that Ms. Huang started to take analgesics which she rarely took before. The pharmacist may also notice three months ago Ms. Huang replace the health product capsule from first generation to the second generation. He reviewed the information, saved in the storage unit5, of the second generation health product capsule, found that the second generation has extra ingredient—Monacolin K which was not comprised in the first generation. Since the medical function might be similar to Atorvastatin series, user who took Monacolin K with Atorvastatin together may cause pain on muscle. Therefore the pharmacist could recommended the user stop using the second generation health product and use the first generation health product again.

The second sub-embodiment illustrate that when consumers/users get prescription medicine and health product, the pharmacist can use analysis of the medicine record and health product record via the present invention to recommend the consumer to buy suitable health product.

### The Third Sub-Embodiment of the First Embodiment

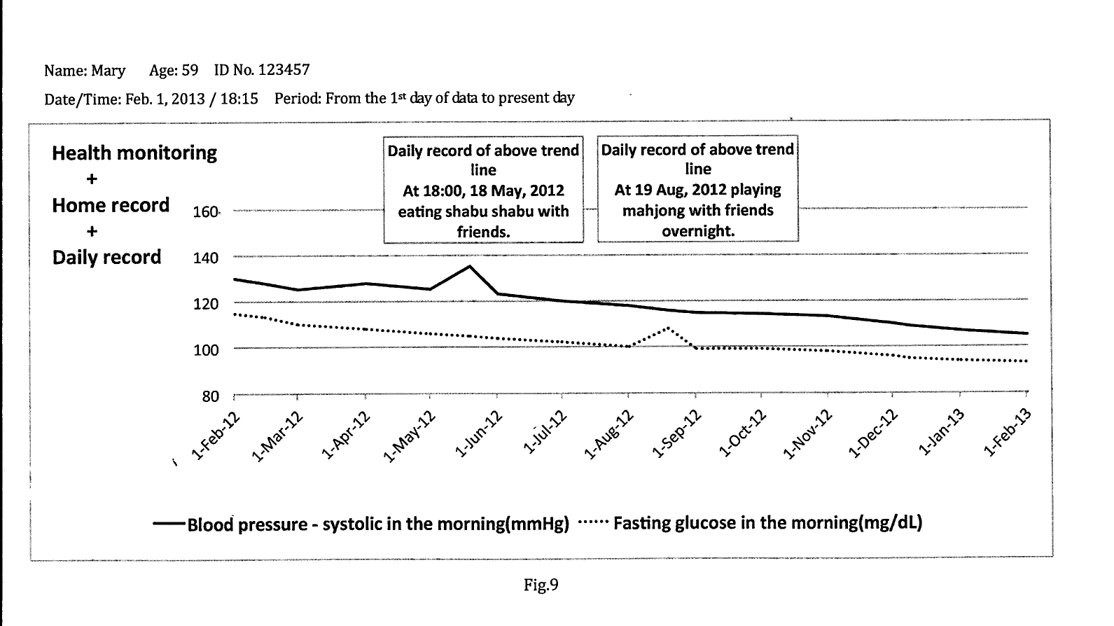

Please refer to FIG. 9, which shows analysis diagram of the third sub-embodiment. In the FIG. 9, vertical axis shows mmHg and mg/dL; the horizontal axis shows the time. The solid line is systolic blood pressure in the morning (mmHg). The dotted line is fasting glucose in the morning (mg/dL). The system will mark on the solid or dotted lines if on the specific time the value of blood pressure or glucose jump up. The FIG. 9 was created based on Mary's data.

Mary and Jenny were twins suffering from Hypertension and Diabetes but not very serious. They both bought the same blood pressure monitors and blood glucose meters and used them every day. However, Mary controlled her blood pressure and blood glucose better than Jenny did. The reason was that Mary know to utilize the present invention in the pharmacy. Every month, Mary upload her examination data to the present invention in the pharmacy. She can use the application software of the present invention record the exercise and living record, using the comparison function. The pharmacist in that pharmacy can, under Mary's permission, also read Mary's data and give her advice. For example, observing the wave of the solid and dotted line, Mary can easily noticed that if she stayed up late, her blood glucose will rise. The reason might probably that staying up cause Endocrine unstable. Therefore Mary tried to sleep regularly. If she went to shabu shabu which having too much sodium in the soup, her blood pressure would rise next day. Therefore Mary could use the record shown in the present invention and also accept the advice from the pharmacist who can access Mary's health data. Pharmacist and other health related member are easy to make a diet, exercise, health product plan for Mary. On the contrary, Jenny who does not use the present invention cannot have such kind of benefit. Even though she can consult the doctor, it is hard for her to make an appointment as she wants. If she goes to the pharmacy without the present invention, the pharmacist does not have detail of Jenny's health data and the recommendation is quite limited. Therefore, the present invention help the pharmacists or other health related member to give suitable diet, exercise, health product plans in an appropriate way based on the habits of diet, exercise, and life style.

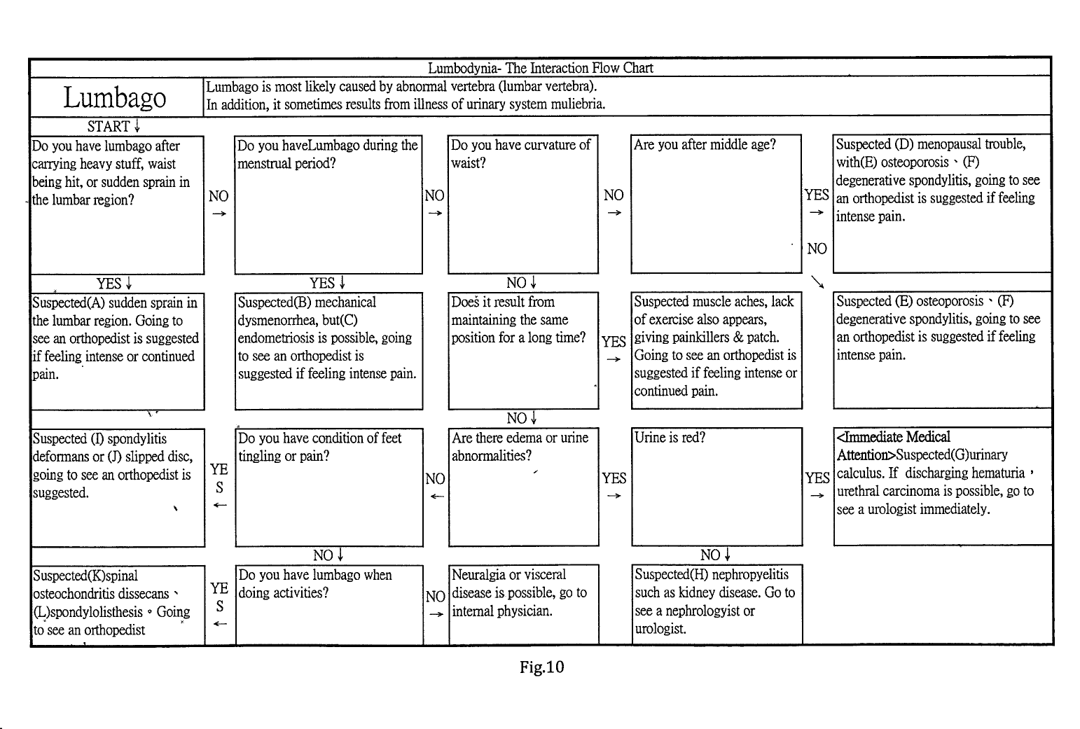

Please refer to FIG. 6. The medicine information 52 of the storage unit 5 has recorded various details of medicines, such as instruction and side effect. The event information 53 informs the user the current activities or events hold by the pharmacy. The medicine knowledge 54 helps to disseminate the knowledge to the user, especially by interaction which the interaction data was saved in the storage unit 5. Please refer to FIG. 10, which is an interaction flow chart for Lumbodynia. The user can directly use the health data collection and analysis device 1 to operate or use hand held device M1 connecting with the health data collection and analysis device 1. Take Lumbodynia for example, the user utilizes interaction flow chart as instruction to find the suitable appointed department, which help the user/patient to save his/her time.

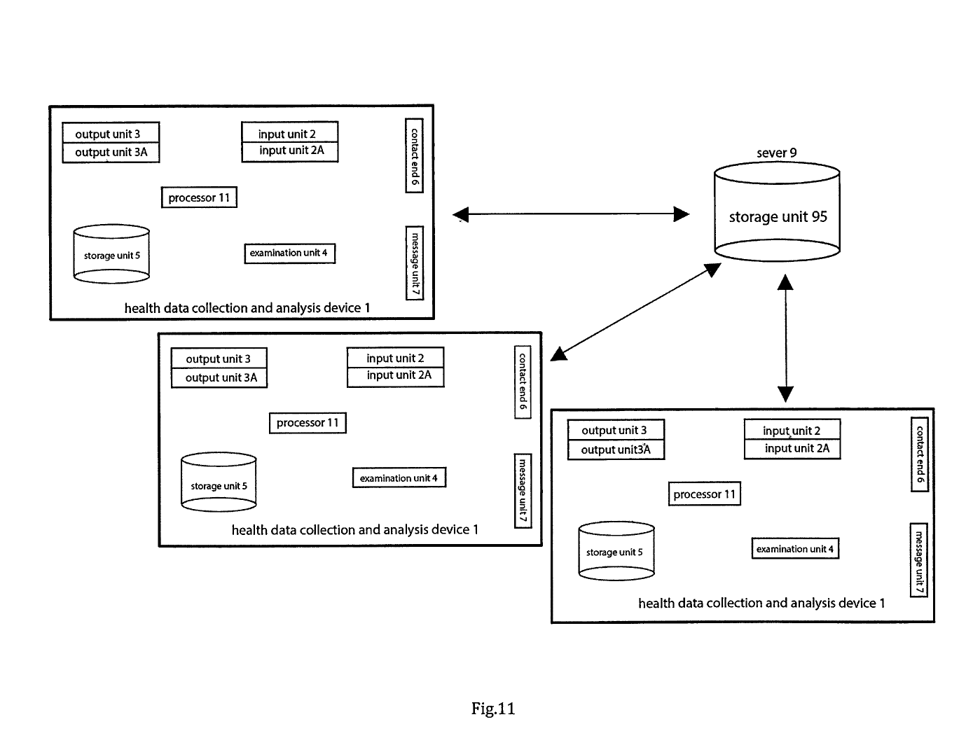

Please refer to FIG. 11, which shows the structure of the second embodiment. The main difference between the first and second embodiments is that the second embodiment has a plurality of health data collection and analysis devices 1 connecting with a server 9 and then integrated to a health data collection and analysis system. The server 9 includes a bigger storage unit 95. When a user uses any one of the health data collection and analysis device 1 without processor or storage unit 5; instead he could use terminal device which comprises input unit, output unit, examination unit to upload and download data/information form the server 9. The server 9 has processor and storage unit which integrate, analyze the saved data. The work creating the analysis chart can be done by the processor of terminal or the processor of the server 9. The present invention in the second embodiment breaks the limit of the territory. When user goes to the pharmacy, medical institution or other health related institution which has the present invention, the examination result/data, medicine record are able to upload to the shared server 9 to keep the integrity of the data.

The embodiments and the technical principles used are described above. All variations and modifications of the present invention and the uses thereof are included in the scope of the present invention if they do not depart from the spirit of the disclosure of this specification and drawings.

What is claimed is:

1. A health data collection and analysis device, comprising:
at least one processor;
at least one input unit for updating a medicine record;
at least one examination unit connecting with the processor and examining a user to obtain at least one examination record;
at least one storage unit for storing the medicine record and the at least one examination record; and
wherein the processor integrates the medicine record and the examination record stored in the at least one storage unit.

2. The health data collection and analysis device of claim 1, wherein the processor adopts time as baseline and compares the medicine record with values in the examination record to create the at least one analysis diagram.

3. The health data collection and analysis device of claim 2, wherein the health data collection and analysis device further comprising an output unit outputting the analysis diagram.

4. The health data collection and analysis device of claim 1, wherein the medicine record includes records of medicine had been taken and records of subjective symptoms.

5. The health data collection and analysis device of claim 4, wherein the at least input unit is used for inputting data of subjective symptoms.

6. The health data collection and analysis device of claim 1, wherein the input unit further comprises an ID confirm unit, the storage unit pre-stored an ID data and the ID confirm unit reads the user's ID data, and the processor compares the ID data with the user's ID data.

7. The health data collection and analysis device of claim 1, wherein the input unit further comprises an ID confirm unit which is a card reader, fingerprint machine, or sensor.

8. The health data collection and analysis device of claim 1, wherein the examination unit includes blood pressure monitor, vascular elasticity monitor, pulse oximeter, body fat monitor scale, or blood glucose meter.

9. The health data collection and analysis device of claim 1, wherein a health product record or a life style record are stored in the storage unit, and the processor adopts time as baseline and compares the change of values in the examination record with events happened in the health product record or a life style record.

10. The health data collection and analysis device of claim 9, wherein the life style record records the user's diet habits and exercise habits.

11. The health data collection and analysis device of claim 1, wherein the health data collection and analysis device further comprises at least one contact end connecting with at least one external examination unit or external storage unit.

12. The health data collection and analysis device of claim 1, wherein the health data collection and analysis device further comprises at least one message unit which is used to communicate with handheld device.

13. The health data collection and analysis device of claim 1, wherein a plurality of interaction flow charts are stored in the storage unit.

14. The health data collection and analysis device of claim 1, wherein the health data collection and analysis device further connects with a server to exchange data.

15. A health data collection and analysis device, comprising:
at least one processor;
at least one input unit for updating a medicine record which includes records of medicine had been taken and records of subjective symptoms;
at least one storage unit for storing the records of medicine had been taken and the records of subjective symptoms; and
wherein the processor integrates the records of medicine had been taken and the records of subjective symptoms.

16. The health data collection and analysis device of claim 15, wherein the processor adopts time as baseline and compares records of medicine had been taken with the records of subjective symptoms to create the at least one analysis diagram.

17. A health data collection and analysis system, comprising:
at least one terminal having at least one input unit for updating a user's medicine record, at least one examination unit for obtaining at least one examination record and at least one output unit; and
at least one server connecting with the terminal and including at least one storage unit for storing the medicine record and examination record collected by the terminal.

18. The health data collection and analysis device of claim 17, wherein the at least one server further comprises at least one processor which adopts time as baseline and compares the medicine record with values in the examination record to create the at least one analysis diagram which feedback to the output unit.

19. The health data collection and analysis device of claim 17, wherein the terminal includes at least one processor and selectively read the medicine record and examination record stored in the at least one storage unit.

20. The health data collection and analysis device of claim 19, wherein the processor adopts time as baseline and compares the medicine record with values in the examination record to create the at least one analysis diagram.
